(19) United States
(12) Patent Application Publication
(10) Pub. No.: US 2013/0090006 A1
(43) Pub. Date: Apr. 11, 2013

(54) Compact adapter to be used as a battery substitute

(71) Applicant: John Thanh Huynh, Springfield, VA (US)

(72) Inventor: John Thanh Huynh, Springfield, VA (US)

(21) Appl. No.: 13/317,049

(22) Filed: Oct. 11, 2011

(51) Int. Cl. H01R 3/00

(52) U.S. Cl. 439/500

(57) ABSTRACT

A compact adapter for providing electrical power to a battery-operated device. The power is derived when the adapter is connected to a common and widely-used AC-DC transformer. The highly portable adapter universally replaces the need for batteries and can be quickly installed in the battery compartment where a battery would otherwise be placed.

### BACKGROUND OF THE INVENTION

1. Field of the Invention

The present invention may be viewed as a battery substitute or alternative. The device is positioned within the battery compartment of an electronic device and acts as the conduit of electrical power between the device and an external power supply or AC-DC transformer.

2. Description of the Related Art

In both households and commercial environments, there are numerous devices requiring batteries, such as handheld electronic controllers, music and media players, and many other household appliances and devices. Some devices have both battery capability and a built-in electricity receiving plug, while some have only battery capability. The disadvantages to batteries are widely understood and they include the high cost of replacement, inconveniences of purchase, upkeep and storage, and environmental harm via landfills when disposed of. Rechargeable batteries tend to be expensive and are inconvenient to use because they get depleted and have to be replaced eventually just like conventional batteries. Furthermore, a user can be stranded with depleted rechargeable batteries just like with conventional batteries.

The prior art has addressed some of these issues, but still faces significant challenges in finding a solution that is easy to manufacture, inexpensive, easy to use, compact, portable, durable, versatile, universal, or a combination thereof.

This invention seeks to solve the shortcomings of the prior art and the inventions found in these patents: Patent Number U.S. Pat. No. 3,586,870 and Patent Number U.S. Pat. No. 6,906,496. This invention, while aiming for the same goals as the referenced inventions, provides benefits that are novel and are improvements to the referenced inventions. Specifically, this invention is very compact and portable while its design is intrinsically easy and inexpensive to manufacture. Moreover, as an example, this invention could fit inside a common eyeglasses case. Hence, there still exists a need for a device that is inexpensive, easy to make, compact, versatile, universal, and highly-portable. This invention embodies the best combination of these criteria.

### SUMMARY OF THE INVENTION

The adapter replaces the need for common batteries, including but not limited to, the following sizes: AAA, AA, C, D, and 9-volt. The adapter is positioned within the battery compartment of a device and the power source, an AC-DC variable transformer, is connected to the adapter directly or through coupling plugs.

The adapter is installed in a manner that resembles a crossbar. The positive tube-tip is the beginning of the crossbar and acts as its front anchor. Interlocking spacers are added in a linear position and pressed together for a snug fit. The last interlocking space in the series will be tucked onto the pre-existing negative spring found within the battery compartment. For C and D sizes, an additional end cap is used to stabilize crossbar. From there, the main wire carries the positive charge to the plug to be connected to the power supply's positive terminal.

The negative charge connection is attained by connecting the connector or metal clip to the spring contact found within the battery compartment. The clip transmits electrical current, via the attached secondary wire, to the negative terminal of the power supply via a plug, special connector, or direct wire connection.

One of the main objectives of the present invention is to provide electricity to a device in lieu of batteries.

Another objective is to provide a device that is lightweight, compact, and highly portable. It is foreseeable that the more portable and compact an adapter can be, the more uses and possible applications a user may discover or innovate for it.

Yet another objective is to provide a device that is inexpensive and easy to manufacture. Still another objective is to provide a device that is versatile and has universal applications, or may be used in a broad number of applications, replacing one or multiple batteries of different sizes.

These and other objects will be apparent to those skilled in the art.

### BRIEF DESCRIPTION OF THE DRAWINGS

FIG. 1 (FIG. 1) showing a top view of the adapter;

FIG. 2 (FIG. 2) showing a top view of FIG. 1 with interlocking spacers;

FIG. 3 (FIG. 3) is an illustrative view of the adapter with various spacers and spring caps; and

FIG. 4 (FIG. 4) showing the adapter in installation mode.

### DETAILED DESCRIPTION OF THE INVENTION (DESCRIPTION OF THE PREFERRED EMBODIMENT)

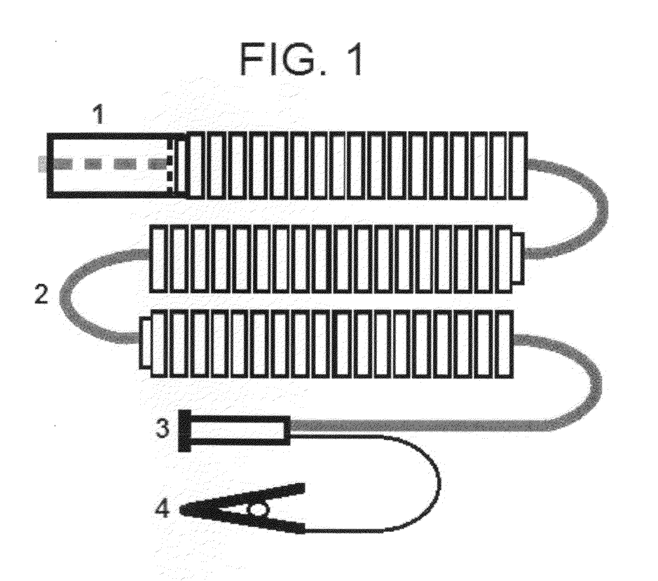

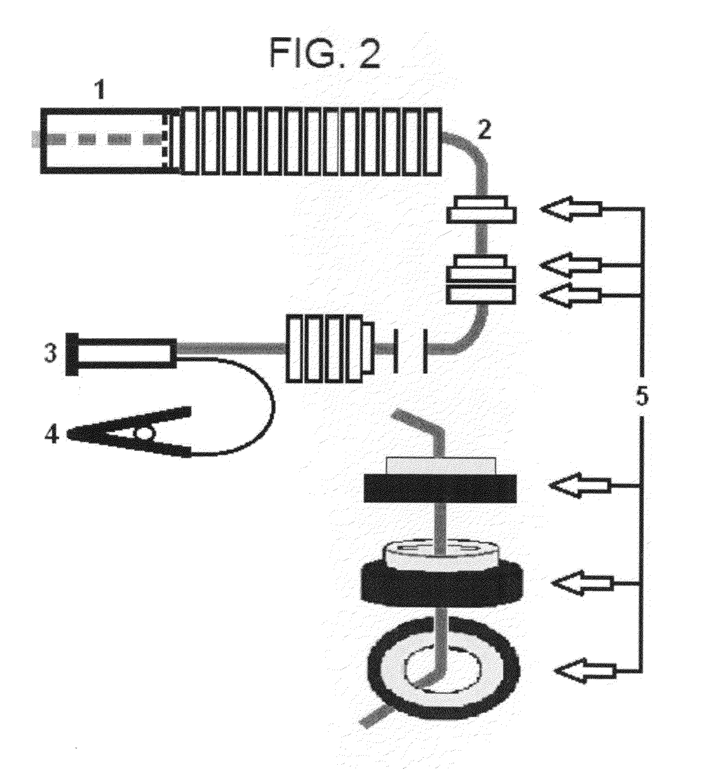

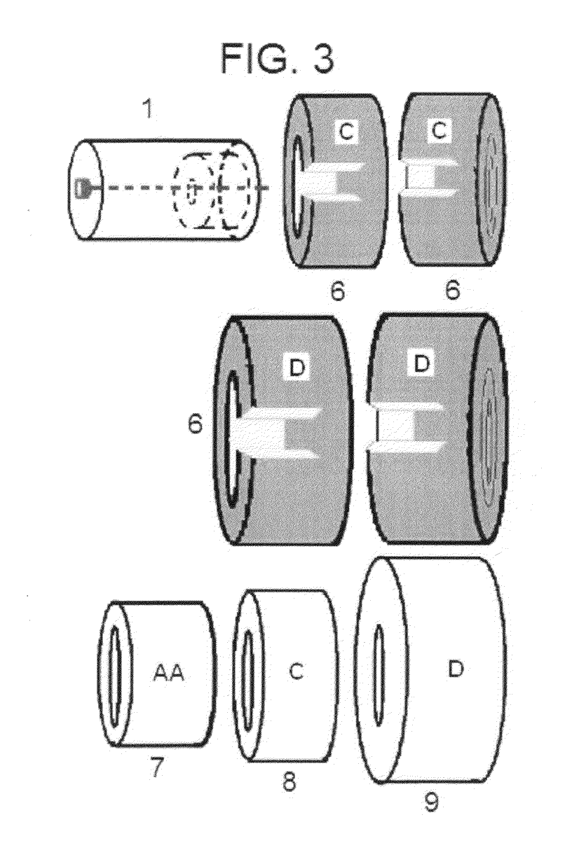

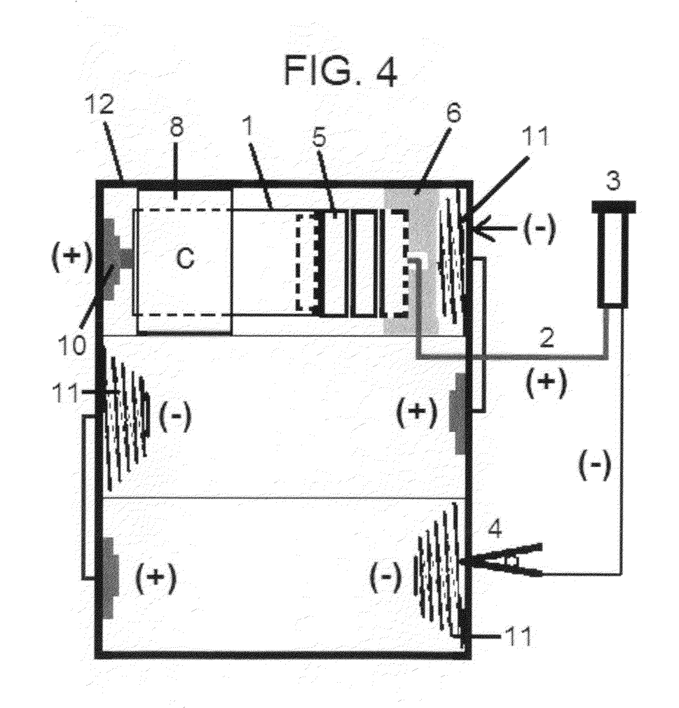

In the drawings, the adapter and its components are identified by the reference numbers 1 through 9 in FIG. 1, FIG. 2 and FIG. 3. The drawing in FIG. 4 shows the adapter as it may be installed in the battery compartment of a device. The battery compartment 12 is shown as a rectangular box with a positive contact plate 10 on one end and a negative spring contact 11 at the other end. In this example, the battery compartment could hold three C-sized batteries, thus there are three positive contact plates 10 and three negative springs 11 shown.

The adapter's tube-tip 1 is a cylindrical tube which contains a metallic conductor tip at the front end of the tube. The protruding metallic tip at the front of the tube is slightly wider and longer than the average width and length of the tip of an AAA-sized battery. The size of the said protruding metallic tip is designed to accommodate the widest possible range of applications (i.e., AAA, AA, C, D, and 9-volt sizes). At the other end of the tube, or the rear of the tube, is an opening that is wide and deep enough to receive an interlocking spacer 5. To provide the positive electrical charge to the device, the tube-tip's conducting metallic tip is placed to make direct contact with the positive conductor plate 10 in the battery compartment. An alternative design, not pictured, is to manufacture the tube-tip 1 with an inner spring. Thus, the tube-tip 1 would have two overlapping cylinders with a spring coil inside it and it would make it easier for the user to install and remove the adapter from the batter compartment.

The interlocking spacers 5 resemble two rings created as a single unit. The bigger ring has an exterior diameter that is the same as tube-tip 1. The smaller ring has a slightly smaller diameter that will fit both inside the customized hole of the tube-tip 1 and the bigger ring of another interlocking spacer 5. Each successive interlocking spacer will stack upon each other snugly to ultimately resemble the form of a crossbar. The core of the interlocking spacer will be a hollowed hole that is wide enough for the main electrical wire 2 to pass through easily. The firmness and strength of the interlocking spacer shall be accomplished by making it out of hard resin, composite, metal, or other hard material. The adapter will provide enough interlocking spacers so that the total length of the tube-tip 1 and the interlocking spacers 5 is about the length of four D-sized batteries combined. Alternatively, the total length of the adapter could be even longer or shorter by user preference. The specified length will allow the adapter to maximize the number of applications used, including most linear and serial alignments of the battery position within a battery compartment.

To install the adapter, the tube-tip 1 is joined with the interlocking spacers 5 by pressing the pieces together in a stacking manner. The user will line up as many interlocking spacers as needed until the length of the battery slot or canal is filled up. The result will resemble a linear crossbar or a firm rod.

The last interlocking spacer 5 at the end of the linear crossbar will be pressed against and hooked up to rest on the pre-existing contact spring 11 in the battery compartment. With enough interlocking spacers in place, the last interlocking spacer will easily hook onto the spring. The linear arrangement and combination of the tube-tip 1, the interlocking spacers 5, and the spring contact 11 will result in a light pressure/tension to keep the adapter (resembling a crossbar) in place. This method is used for substituting AA and AAA-sized batteries. In the case of a C or D-sized battery substitution, the spring cap 6 will be placed after the last interlocking spacer 5. The spring cap 6 has a slot to custom-fit the interlocking spacer, thereby providing stability and firm contact with the contact spring 11. In either the C or D application, a corresponding spring cap 6 is used whenever the adapter is replacing a C or D batteries.

The spring cap 6 has special designs consisting of the following: (1) on the front side, there is a hole that has sufficient width for the interlocking spacer 5 to fit in easily and snugly; and the hole has a depth sufficient for an interlocking spacer to anchor inside it; (2) on the back side of the spring cap are circular rings grooved slightly in depth to provide secure contacts with the negative spring 11; and (3) along the side of the spring cap is an opening that extends from the center core all the way through the side so that the main electrical wire 2 can be let out to prevent the wire from touching and being pressed by the negative spring 11, thereby reducing its frictional wear.

The drawing in FIG. 4 illustrates an example of the adapter installed in a battery compartment 12. This is one of many variations of battery compartments that the adapter may be used in. In this example, the compartment was built to hold three C batteries. Thus, a wheel-shaped spacer 8 which is mounted over the tube-tip 1, is used because it is replacing a C battery. The spacer 8 helps to provide stability because it is the same width as the C battery it is replacing. Similarly, to replace a D battery, the spacer 9 would be used by installing it over the tube-tip 1. Likewise, the spacer 7 would be used to replace an AA battery. Each spacer (7, 8, or 9) will contain a center hole that has a diameter sufficient to slide onto and fit snugly over the tube-tip 1. Furthermore, simple additional features may be introduced, such as adding texture or gridlines to the surfaces, to help the spacers minimize slippage or stay in place when it's enveloping the tube-tip 1. Alternatively, the spacer may be made of rubber or foam which would also minimize slippage.

To complete the flow of electricity, the negative connector or metal clip 4 is attached to the contact spring 11 in order to carry the negative charge in conduit with the AC-DC transformer, or power supply. The connector 4 may be a specially designed connector or a conventional miniature-sized alligator-type metal clip.

Once the adapter is installed as described above, the connecting plug, female type 3 is joined with a matching plug, male type, supplied by a power source or an AC-DC variable transformer. Such plugs and transformers are already in wide use and can be purchased at a department store or other places. The user will select the appropriate voltage needed for the particular application by adjusting a switch or dial on the transformer itself.

Alternatively, the adapter may be connected directly to a transformer so that the plug 3 will not be needed. In that case, the wire connecting the transformer which contains the negative charge will be directly connected to a connector or metal clip 4, and the other wire, the positive wire, of the transformer will be connected directly to the main electrical wire 2.

From the descriptions above, it can be understood that the full path of the positive charge starts at the positive contact plate 10, and is transmitted onto the tube-tip 1, which is connected to the main electrical wire 2, which runs through all of the interlocking spacers 5, and concludes at the connector plug 3. Alternatively, the main wire 2 may be connected directly to the transformer without the use of an intermediary connector plug 3. As for the negative charge, it is simply wired from the transformer directly onto to the plug 3 or the connector/metal clip 4 in the alternative.

In the application of a 9-volt battery substitution, the positive charge may be connected by using an electrical wire with metal clips on both ends, such as ones widely used and available in the marketplace. One metal clip will be connected to the positive ring of the 9-volt battery plug supplied by the battery compartment and the other metal clip will be connected to the metal tip of the tube-tip 1. The adapter's negative connector or metal clip 4 will be directly connected onto the negative ring of the 9-volt battery plug to complete the electrical circuit and provide power.

The adapter and its component units may be made of plastic, metal, rubber, or other material providing durability and strength.

The specifications and drawings of the invention set forth the preferred embodiments that are of a descriptive nature only and they do not limit the invention in the event of variations and modifications that may be within the scope and spirit of the invention.

1. A device and method for providing electrical power to a battery-operated device, made of small spacers and tubes of different sizes, threaded together by a single electrical wire, intrinsically adjustable in length by means of interlocking or interconnecting spacers, to be securely braced within a battery compartment in such a way that the adapter resembles the form and function of a crossbar, while the spring and the positive contact plate, both pre-existing in the battery compartment, act naturally to provide a light and sufficient pressure to hold in place the adapter in a linear form once the interlocking spacers are pressed together successively behind the front tube-tip, wherein the positive electrical charge is transmitted through the wire of the adapter to the front positive tube-tip and makes contact with the positive contact plate, while the negative electrical charge is connected by a separate electrical wire whereby a metal clip is connected to said wire and the prongs of the metal clip are connected to the pre-existing spring, wherein both wires, one transmitting the positive charge while the other transmitting the negative charge, are connected to an electrical plug, such as the commonly found and ubiquitous female-type, direct current, electrical plug, in order to receive exterior power from a variable AC-DC transformer, which are also commonly found and ubiquitous.

2. In relation to claim 1, the compact adapter consists of specially-designed spacers for providing stability at both ends of the adapter, with the front spacers to be mounted onto the front positive tube-tip, which transmits the positive charge, and which spacers have individual exterior diameters roughly equivalent to the battery sizes AA, C, and D, while all of the front spacers share a common interior diameter that is roughly equivalent to the exterior diameter front tube-tip, and with a specially-designed spacer called a spring cap, which is mounted at the end of the adapter, where the negative charge resides, which has roughly the shape of a wheel and has unique carve-outs in three areas, to provide mounting, and to lessen pressure and wear on the electrical wire, while providing an enhanced platform for a more stabilizing fit in relation to the spring, such that the spring cap sits between the spring and the last-in-line interlocking spacer being used.
